(19) United States
(12) Patent Application Publication
(10) Pub. No.: US 2022/0097880 A1
(43) Pub. Date: Mar. 31, 2022

(54) DOUGHNUT PACKAGING ASSEMBLY

(71) Applicant: Andrew James Glennon, Indianapolis, IN (US)

(72) Inventor: Andrew James Glennon, Indianapolis, IN (US)

(21) Appl. No.: 16/948,696

(22) Filed: Sep. 29, 2020

(51) Int. Cl. B65B 9/06; A23G 3/34; A21D 13/60

(52) U.S. Cl. CPC B65B 9/06; A21D 13/60; A23G 3/343

(57) ABSTRACT

A ready-to-make unbaked doughnut doughs packaging assembly. The assembly includes a first tube housing a plurality of pre-made doughnuts tightly-packed between two endcaps, the endcaps sealed on each end of the first tube. A second tube extending through each hole of each pre-made doughnut, wherein the second tube houses a compact topping, the compact topping having an inherent resistance to deformation so that the second tube maintains a cylindrical shape with a consistent diameter to which each hole's inner diameter shares.

### BACKGROUND OF THE INVENTION

The present invention relates to food products and, more particularly, an assembly, a system and a method for providing properly shaped doughnut dough in an airtight cylinder. The assembly provides a plurality of doughnuts sandwiched between an inner surface of a first tube and the outer surface of a second tube disposed between the hole portion of the doughnuts. The second tube houses a compactable topping, such as glaze and/or frosting, having a consistency and viscosity that sufficiently maintains a cylindrical shape of the second tube. This cylindrical shape supports the inner diameter of the doughnut holes and those the overall quintessential shape of the doughnuts until the first tube is opened.

Currently, there is no ready to make doughnuts sold in markets, whereby a consumer can purchase airtight-sealed doughnuts with their hallmark hole. Sure, there are bags of doughnuts, which are not air-tight fresh, and there are rolls of doughnuts, that lack the hole, but no naked doughnuts sold in an airtight package along with toppings a consumer can create their desired fix. Of the dough-based, air-tight offerings that are available today, completion requires one to form the doughnut shapes by hand which ends in less than perfect doughnuts. Additionally, they offer no glaze/frosting nor toppings in a manner that facilitates the proper shaping of the end product.

As can be seen, there is a need for an assembly, a system and a method for providing an air-tight container of doughnut dough properly shaped as doughnuts. The assembly includes a tube of frosting/glaze in the center of the larger tube of doughnuts, keeping the doughnut hole in perfect doughnut shape. The tube of frosting/glaze in the center of my can of doughnut dough keeps the not-yet-made dough in perfect doughnut shape. Additionally, the larger first tube also accommodates a packet of separate dry toppings, such as candy, and thus a consumer of the present invention is provided everything they need to make the perfect doughnut at home. The present invention is meant to be a “take-and-fry” doughnut system.

### SUMMARY OF THE INVENTION

In one aspect of the present invention, a doughnut packaging assembly of unadorned doughnuts includes the following: a first tube housing a plurality of doughnuts; the plurality of doughnuts sandwiched between two endcaps, the two endcaps sealed on each end of the first tube, respectively; and a second tube extending through each hole of each doughnut, wherein the second tube houses a compact topping, the compact topping having an inherent resistance to deformation so that the second tube maintains a cylindrical shape with an outer diameter defining an inner diameter of each hole.

In another aspect of the present invention, a doughnut packaging assembly of unadorned doughnuts includes the following: a first tube housing a plurality of doughnuts, wherein an inner doughnut hole diameter is one-third to one-quarter of an outer doughnut diameter of each of the plurality of doughnuts; the plurality of doughnuts sandwiched between two endcaps, the two endcaps sealed on each end of the first tube, respectively; a second tube extending through each hole of each doughnut, wherein the second tube houses a compact topping, the compact topping having an inherent resistance to deformation so that the second tube maintains a cylindrical shape with an outer diameter defining an inner diameter of each hole, wherein the compact topping is frosting and/or glaze; a packet of loose toppings sandwiched between one of the two endcaps and the plurality of doughnuts; and a tear corner along the packet of loose toppings, wherein the packet of toppings houses candy and/or sprinkles.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a longitudinal cross section view of FIG. 1; and

FIG. 3 is an exploded perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a ready-to-make doughnut packaging assembly. The assembly includes a first tube for housing a plurality of doughnut doughs tightly-packed between two endcaps, the endcaps sealed on each end of the first tube. A second tube extending through each hole of each doughnut, wherein the second tube houses a compact topping, the compact topping having an inherent resistance to deformation so that the second tube maintains a cylindrical shape with a consistent diameter to which each hole's inner diameter shares.

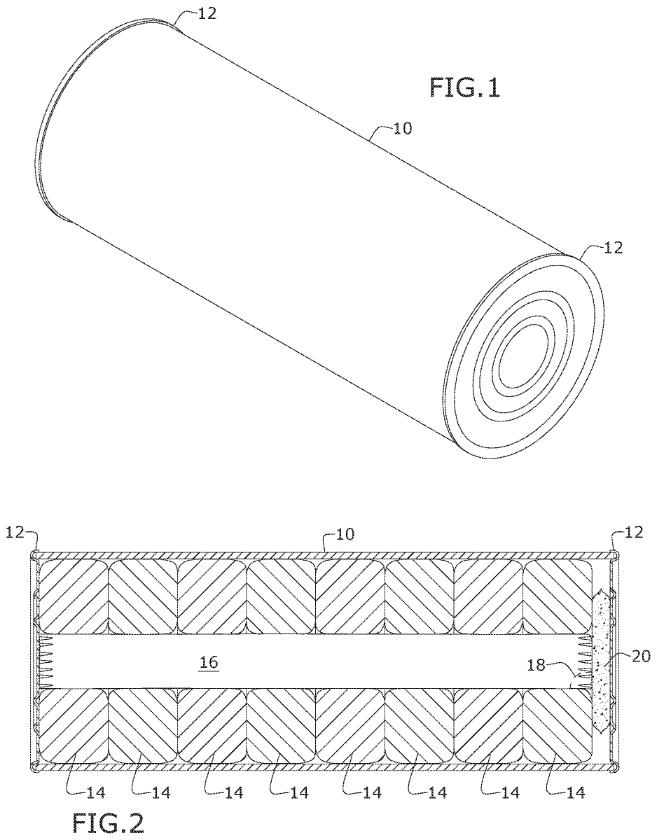

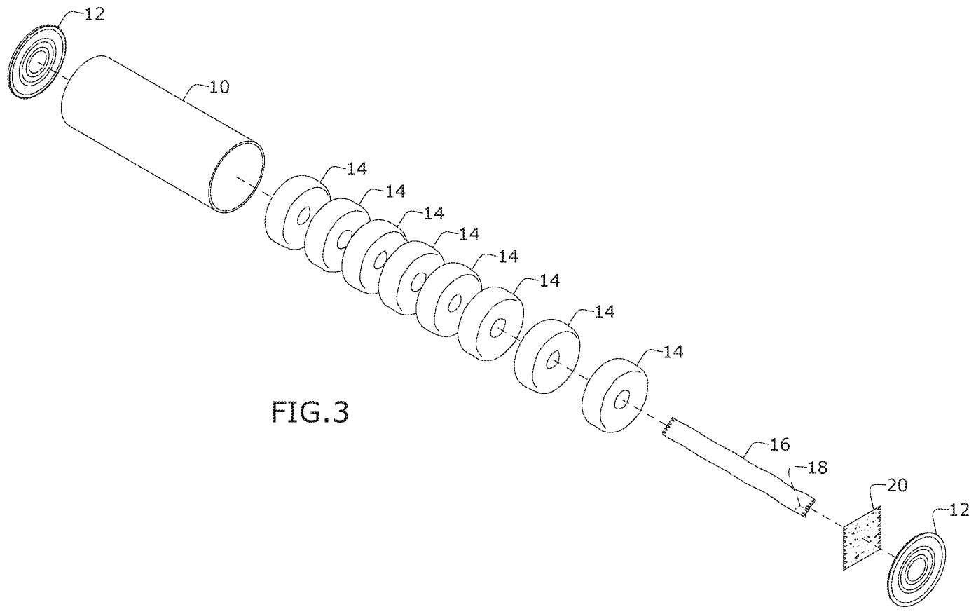

Referring now to FIGS. 1 through 3, the present invention may provide an assembly for packaged, air-tight, ready-to-make doughnuts. The assembly includes a first tube 10 capped at both ends by end caps 12. Within the first lumen of the first tube 10 are a plurality of doughnuts 14, each doughnut 14 having the hallmark doughnut shape including the doughnut hole that is approximately one-third to one-fourth in diameter relative to its doughnut 14. A second tube 16 is disposed through the doughnut holes of the plurality of doughnut dough pieces 14. The second tube 16 may be dimensioned to provide an outer diameter/circumference shared by an inner diameter/circumference of the doughnut holes of the plurality of doughnut dough pieces 14. The second tube 16 may house a compact topping, such as frosting, glaze, or the like that has a high resistance to deformation or high viscosity so that a cylindrical shape of the second tube 16 can be maintained within the holes of the doughnuts 14.

The first tube 10 may be made of cardboard or other paper products. The end caps 12 may be made of metallic material. The second tube 16 may be made of plasticized material. Between the plurality of doughnut dough pieces 14 and one of the end caps 12 may be a packet 20 of a second topping, such as candy or other loose sprinkles. The packet 20 may have a tear corner 18.

The second tube 16 extending through the center of the plurality of doughnut dough pieces 14 maintains the perfect doughnut shape with the hallmark doughnut holes. The second tube 16 of frosting through the center of the doughnut dough is vital, without it the doughnuts 14 would lose their shape.

The topping packet 20 is included inside and sealed in by the metal end caps 12 along with the plurality of doughnuts 14.

A method of using the present invention would include the following. Upon receipt of the air-tight sealed doughnuts a user would open up one of the end caps 12 and remove the plurality of doughnuts 14, the second tube 16 and the packet 20 of second topping. The doughnuts 14 being uncooked doughnut dough, the purchaser will then be able to enjoy the excitement of actually cooking their own doughnuts so they are fresh, then adorning the made doughnuts with the glaze from the second tube 16. Then the user may remove the tear-off corner 18 of the topping packet 20 and assemble the desired combination of compact topping and loose topping on as many doughnuts 14 as their heart desires.

It should be understood, of course, that the foregoing relates to exemplary embodiments of the invention and that modifications may be made without departing from the spirit and scope of the invention as set forth in the following claims.

What is claimed is:

1. A doughnut packaging assembly of doughnut doughs, comprising:
a first tube housing a plurality of doughnut doughs;
the plurality of doughnut doughs sandwiched between two endcaps, the two endcaps sealed on each end of the first tube, respectively; and
a second tube extending through each hole of each doughnut dough, wherein the second tube houses a compact topping, the compact topping having an inherent resistance to deformation so that the second tube maintains a cylindrical shape with an outer diameter defining an inner diameter of each hole.

2. The doughnut packaging assembly of claim 1, wherein the plurality of doughnut doughs are unadorned and unbaked.

3. The doughnut packaging assembly of claim 1, wherein the inner diameter is one-third to one-quarter of an outer doughnut diameter of each of the plurality of doughnut doughs.

4. The doughnut packaging assembly of claim 1, wherein the compact topping is frosting and/or glaze.

5. The doughnut packaging assembly of claim 1, further comprising a packet of toppings sandwiched between one of the two endcaps and the plurality of doughnuts.

6. The doughnut packaging assembly of claim 5, further comprising a tear corner along the packet of toppings.

7. The doughnut packaging assembly of claim 5, wherein the packet of toppings houses candy and/or sprinkles.

8. A doughnut packaging assembly of unbaked doughnut doughs, comprising:
a first tube housing a plurality of unbaked doughnut doughs, wherein an inner doughnut hole diameter is one-third to one-quarter of an outer doughnut diameter of each of the plurality of unbaked doughnut doughs;
the plurality of unbaked doughnut doughs sandwiched between two endcaps, the two endcaps sealed on each end of the first tube, respectively;
a second tube extending through each hole of each doughnut, wherein the second tube houses a compact topping, the compact topping having an inherent resistance to deformation so that the second tube maintains a cylindrical shape with an outer diameter defining an inner diameter of each hole, wherein the compact topping is frosting and/or glaze;
a packet of loose toppings sandwiched between one of the two endcaps and the plurality of unbaked doughnut doughs; and
a tear corner along the packet of loose toppings, wherein the packet of toppings houses candy and/or sprinkles.
